(19) United States
(12) Patent Application Publication
(10) Pub. No.: US 2007/0052679 A1
(43) Pub. Date: Mar. 8, 2007

(54) TRANSPARENT KEY OF AN ELECTRONIC DEVICE

(75) Inventor: JEN-YU LIANG, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,635

(22) Filed: Apr. 14, 2006

(30) Foreign Application Priority Data
Jul. 8, 2005 (CN) 200510035935.4

(51) Int. Cl. G09G 5/00

(52) U.S. Cl. 345/168

(57) ABSTRACT

A transparent key (100) of an electronic device includes a patterned portion (10) and a peripheral portion (11) surrounding the patterned portion. The patterned portion and the peripheral portion co-form a pressing portion (12), or one of the patterned portion and the peripheral portion forms the pressing portion. One of the patterned portion and the peripheral portion is made of silica gel, and the other one is made of plastic. The transparent key of an electronic device further includes a driving block protruded from the patterned portion or the peripheral portion, for electrically connecting the key and a printed circuit board (PCB). The transparent key of an electronic device made of silica gel has good feeling and long using life.

### FIELD OF THE INVENTION

The present invention relates to transparent keys of electronic devices, and particular to a co-injection molding transparent key of an electronic device.

### DESCRIPTION OF RELATED ART

Conventionally, operation buttons in the form of an array of transparent keys are used in all kinds of portable electronic devices, such as portable computers or mobile telephones. The transparent keys of electronic devices including a backlighting component can be conveniently manipulated even under poor lighting conditions or in darkness.

Nowadays, there are two kinds of transparent keys: one is plastic keys filmed with metal, and the other one is all plastic keys. The keys filmed with the metal have characteristics of good feeling and appearance. However, the metal films may become worn over time. The all plastic keys have lower cost, however, feeling and appearance of the all plastic keys are less satisfactory.

### SUMMARY OF INVENTION

An exemplary embodiment of the invention provides a transparent key of an electronic device, for mounting on a printed circuit board (PCB). The transparent key of an electronic device includes a patterned portion and a peripheral portion surrounding the patterned portion. The patterned portion and the peripheral portion co-form a pressing portion. One of the patterned portion and the peripheral portion is made of silica gel, and the other one is made of plastic.

Another exemplary embodiment of the invention provides a transparent key of an electronic device, for mounting on a printed circuit board (PCB). The transparent key of an electronic includes a patterned portion and a peripheral portion surrounding the patterned portion. One of the patterned portion and the peripheral portion forms a pressing portion. One of the patterned portion and the peripheral portion is made of silica gel, and the other one is made of plastic.

Other advantages and novel features will be drawn from the following detailed description of preferred embodiments with the attached drawings, in which:

### BRIEF DESCRIPTION OF DRAWINGS

FIG. 1A is a top elevation view of a transparent key of an electronic device in accordance with a first exemplary embodiment of the invention;

FIG. 1B is a cross-sectional view taken along line B-B of FIG. 1A;

FIG. 2A is a top elevation view of a transparent key of an electronic device in accordance with a second exemplary embodiment of the invention;

FIG. 2B is a cross-sectional view taken along line B-B of FIG. 2A;

FIG. 3A is a top elevation view of a transparent key of an electronic device in accordance with a third exemplary embodiment of the invention;

FIG. 3B is a cross-sectional view taken along line B-B of FIG. 3A;

FIG. 4A is a top elevation view of a transparent key of an electronic device in accordance with a fourth exemplary embodiment of the invention;

FIG. 4B is a cross-sectional view taken along line B-B of FIG. 4A;

FIG. 5A is a top elevation view of a transparent key of an electronic device in accordance with a fifth exemplary embodiment of the invention;

FIG. 5B is a cross-sectional view taken along line B-B of FIG. 5A.

### DETAILED DESCRIPTION

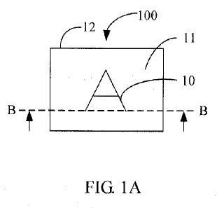

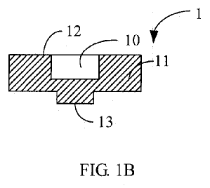

FIG. 1A is a top elevation view of a transparent key 100 of a electronic device (not shown) in accordance with a first exemplary embodiment, and FIG. 1B is a cross-sectional view taken along line B-B of FIG. 1A. The transparent key 100 includes a patterned portion 10, a peripheral portion 11 surrounding the patterned portion 10, and a driving block 13. The driving block 13 is protruded from the peripheral portion 11, for electrically connecting the transparent key 100 to a printed circuit board (PCB) (not shown). The patterned portion 10 and the peripheral portion 11 co-form a pressing portion 12.

In the exemplary embodiment, the transparent key 100 is made of plastic and silica gel. The plastic is used for forming the patterned portion 10 of the transparent key 100. Similarly, the silica gel is used for forming the peripheral portion 11 of the transparent key 100. The patterned portion 10 and the peripheral portion 11 can be of same or different color. In the exemplary embodiment, the patterned portion 10 of the transparent key 100 is not fully covered with the peripheral portion 11. In the exemplary embodiment, while the patterned portion 10 is made of transparent plastic, the peripheral portion 11 can be made of transparent silica gel or non-transparent silica gel. In another exemplary embodiment, the patterned portion 10 is made of non-transparent plastic, and the peripheral portion 11 of transparent silica gel.

In order to easily identify the patterned portion 10 on the transparent key 100, the transparent plastic and the transparent silica gel are preferably in different colors patterned portion and peripheral portion.

In the exemplary embodiment, the pressing portion 12 is plane, or tridimensional.

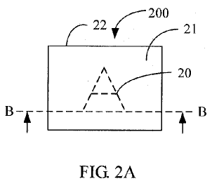

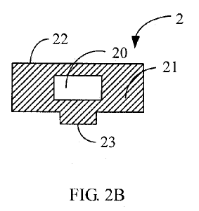

FIG. 2A is a top elevation view of a transparent key 200 of an electronic device (not shown) in accordance with a second exemplary embodiment, and FIG. 2B is a cross-sectional view taken along line B-B of FIG. 2A. In the exemplary embodiment, the transparent key 200 also includes a patterned portion 20, a peripheral portion 21 surrounding the patterned portion 20, and a driving block 23. The driving block 23 is protruded from the peripheral portion 21, for electrically connecting the transparent key 200 to a PCB (not shown). The difference between the transparent key 100 of FIG. 1A and the transparent key 200 is that the patterned portion 20 is fully covered by the peripheral portion 21. Therefore, the peripheral portion 21 forms a pressing portion 22. In the exemplary embodiment, the peripheral portion 21 is made of transparent silica gel, and the patterned portion 20 is made of transparent plastic or non-transparent plastic.

Similarly, in the exemplary embodiment, the pressing portion 22 is plane, or tridimensional. In addition, the transparent plastic and the transparent silica gel are preferably in different colors patterned portion and peripheral portion.

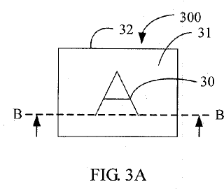

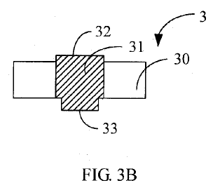

FIG. 3A is a top elevation view of a transparent key 300 of an electronic device (not shown) in accordance with a third exemplary embodiment, and FIG. 3B is a cross-sectional view taken along line B-B of FIG. 3A. In the exemplary embodiment, the transparent key 300 includes a patterned portion 30, a peripheral portion 31 around the patterned portion 30, and a driving block 33 that is protruded from the patterned portion 30, for electrically connecting the transparent key 300 to a PCB (not shown). In the exemplary embodiment, while the patterned portion 30 is made of transparent silica gel, the peripheral portion 31 can be made of transparent plastic or non-transparent plastic. In another exemplary embodiment, the patterned portion 30 is made of non-transparent silica gel, and the peripheral portion 31 is made of transparent plastic.

In addition, in the exemplary embodiment, the patterned portion 30 has a raised surface 321 that is higher than the peripheral portion 31. The raised surface 321 forms a pressing portion 32 that is made of silica gel.

Similarly, in the exemplary embodiment, the pressing portion 32 is plane, or tridimensional. In addition, the transparent plastic and the transparent silica gel are preferably in different colors patterned portion and peripheral portion. In the exemplary embodiment, because the key pressing 32 is very small, in order to increase life of the transparent key 300, the pressing portion 32 is a solid tridimensional portion.

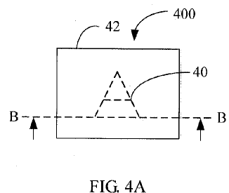

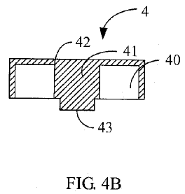

FIG. 4A is a top elevation view of a transparent key 400 of an electronic device (not shown) in accordance with a fourth exemplary embodiment, and FIG. 4B is a cross-sectional view taken along line B-B of FIG. 4A. In the exemplary embodiment, the transparent key 400 also includes a patterned portion 40, a peripheral portion 41 surrounding the patterned portion 40, and a driving block 43. The driving block 43 is protruded from the patterned portion 40, for electrically connecting the transparent key 400 to a PCB (not shown), which is the same as that of the transparent key 300 of FIG. 3A. The difference between the key 400 and the transparent key 300 is that the patterned portion 40 and the peripheral portion 41 are fully covered with silica gel. In the exemplary embodiment, the patterned portion 40 and the peripheral portion 41 co-form a pressing portion 42. In addition, the patterned portion 40 is made of the transparent silica gel, and the peripheral portion 41 is made of transparent plastic or non-transparent plastic.

Similarly, in the exemplary embodiment, the pressing portion 42 is plane, or tridimensional. In addition, the transparent plastic and the transparent silica gel are preferably in different colors patterned portion and peripheral portion.

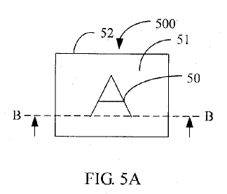

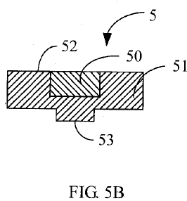

FIG. 5A is a top elevation view of a transparent key 500 of an electronic device (not shown) in accordance with a fifth exemplary embodiment, and FIG. 5B is a cross-sectional view taken along line B-B of FIG. 5A. In the exemplary embodiment, the transparent key 500 also includes a patterned portion 50, a peripheral portion 51 surrounding the patterned portion 50, and a driving block 53. The patterned portion 50 and the peripheral portion 51 co-form a pressing portion 52, and the driving block 53 is protruded from the peripheral portion 51.

The difference between the transparent key 500 and the transparent key 100 in FIG. 1A is that the transparent key 500 is made of two different colors of silica gel. In the exemplary embodiment, both of the patterned portion 50 and the peripheral portion 51 can be made of transparent silica gel. In another exemplary embodiment, one of the patterned portion 50 and the peripheral portion 51 can be made of the transparent silica gel, and the other one can be made of the non-transparent silica gel. Because the silica gel is soft, in order to have good stability, a first molded one of the patterned portion 50 and the peripheral portion 51 is harder than the latter one.

Similarly, in the exemplary embodiment, the pressing portion 52 is plane, or tridimensional.

While particular embodiments have been described above, it should be understood that it has been presented by way of example only and not by way of limitation. Thus the breadth and scope of the present invention should not be limited by the above-described exemplary embodiments, but should be defined only in accordance with the following claims and their equivalents.

What is claimed is:

1. A transparent key of an electronic device, for mounting on a printed circuit board (PCB), comprising:
a patterned portion; and
a peripheral portion surrounding the patterned portion;
wherein the patterned portion and the peripheral portion co-form a pressing portion, and one of the patterned portion and the peripheral portion is made of silica gel.

2. The transparent key of an electronic device as recited in claim 1, wherein the other one of the patterned portion and the peripheral portion is made of plastic.

3. The transparent key of an electronic device as recited in claim 1, further comprising a driving block protruded from the patterned portion, for electrically connecting the key to the PCB.

4. The transparent key of an electronic device as recited in claim 1, further comprising a driving block protruded from the peripheral portion, for electrically connecting the key to the PCB.

5. The transparent key of an electronic device as recited in claim 1, wherein both of the patterned portion and the peripheral portion are transparent.

6. The transparent key of an electronic device as recited in claim 5, wherein the patterned portion and the peripheral portion are different colors.

7. The transparent key of an electronic device as recited in claim 1, wherein one of the patterned portion and the peripheral portion is transparent, and the other one is opaque.

8. The transparent key of an electronic device as recited in claim 1, wherein the pressing portion can be a plane, or tridimensional.

9. A transparent key of an electronic device, for mounting on a printed circuit board (PCB), comprising:
a patterned portion; and
a peripheral portion surrounding the patterned portion;
wherein one of the patterned portion and the peripheral portion forms a pressing portion, and one of the patterned portion and the peripheral portion is made of silica gel.

10. The transparent key of an electronic device as recited in claim 9, wherein the patterned portion comprises a raised surface being higher than the peripheral portion.

11. The transparent key of an electronic device as recited in claim 10, wherein the raised surface forms the pressing portion.

12. The transparent key of an electronic device as recited in claim 9, wherein the other one of the patterned portion and the peripheral portion is made of plastic.

13. The transparent key of an electronic device as recited in claim 9, further comprising a driving block protruded from the patterned portion, for electrically connecting the key to the PCB.

14. The transparent key of an electronic device as recited in claim 9, further comprising a driving block protruded from the peripheral portion, for electrically connecting the key to the PCB.

15. The transparent key of an electronic device as recited in claim 9, wherein one of the patterned portion and the peripheral portion is transparent, and the other one is opaque.

16. The transparent key of an electronic device as recited in claim 9, wherein both of the patterned portion and the peripheral portion are transparent.

17. The transparent key of an electronic device as recited in claim 16, wherein the patterned portion and the peripheral portion are different colors.

18. The transparent key of an electronic device as recited in claim 9, wherein the pressing portion can be a plane, or tridimensional.
